(19) United States
(12) Patent Application Publication
(10) Pub. No.: US 2025/0184825 A1
(43) Pub. Date: Jun. 5, 2025

(54) COMMUNICATION DEVICE, CONTROL METHOD THEREOF, AND STORAGE MEDIUM

(71) Applicant: CANON KABUSHIKI KAISHA, Tokyo (JP)

(72) Inventor: SHOKI MASHIYAMA, Saitama (JP)

(21) Appl. No.: 18/948,127

(22) Filed: Nov. 14, 2024

(30) Foreign Application Priority Data
Nov. 30, 2023 (JP) 2023-202363

(51) Int. Cl. H04W 28/086; H04L 67/75; H04W 48/20

(52) U.S. Cl. CPC H04W 28/0866; H04L 67/75; H04W 48/20

(57) ABSTRACT

A communication device that executes communication compliant with Institute of Electrical and Electronics Engineers (IEEE) 802.11 standard, the communication device including at least one memory storing instructions, and at least one processor in communication with the at least one memory and, upon executing the stored instructions, the at least one processor is configured to operate as: a search unit configured to search for an access point, and a display control unit configured to cause display, on a display device, search results representing one or more access points returned from the search, wherein a first access point that complies with the multi-link communication defined in the IEEE 802.11 standard is displayed as the search result in such a manner as to be distinguishable by a user from other access points returned in the search.

### BACKGROUND

### Field

The present disclosure relates to a communication device, a control method thereof, and a storage medium.

### Description of the Related Art

With a recent increase in an amount of data to be communicated, the development of a communication technique, such as a wireless local area network (LAN), has been advanced. As a major communication standard of the wireless LAN, the Institute of Electrical and Electronics Engineers (IEEE) 802.11 standard series has been known. The IEEE 802.11 standard series includes standards, such as IEEE 802.11a/b/g/n/ac/ax. For example, in the IEEE 802.11ax, a technique of achieving high peak throughput up to 9.6 gigabit per second (Gbps) using orthogonal frequency-division multiple access (OFDMA), and also improving a communication speed under a congested situation is standardized (see Japanese Patent Application Laid-Open No. 2018-50133).

As the development of the IEEE 802.11 standard series has been advanced, for example, a task group called IEEE 802.11be has started as a succeeding standard aimed at further throughput enhancement, improvement in frequency usage efficiency, and improvement in communication latency. In the IEEE 802.11be standard, for example, multi-link communication has been studied to realize establishment of a plurality of links by one access point (AP) with one station (STA) via a plurality of different frequency channels and concurrent communication.

A technique in which a communication state in a communication device is output via a screen or the like is generally utilized to provide a user with the communication state. However, how to output the communication state in a case where the communication device supports a new communication standard has not been studied.

### SUMMARY

The present disclosure is directed to providing a method for causing a user to suitably recognize a communication state in a communication device that supports a new communication standard.

A communication device that executes communication compliant with Institute of Electrical and Electronics Engineers (IEEE) 802.11 standard, the communication device including at least one memory storing instructions, and at least one processor in communication with the at least one memory and, upon executing the stored instructions, the at least one processor is configured to operate as: a search unit configured to search for an access point, and a display control unit configured to cause display, on a display device, search results representing one or more access points returned from the search, wherein a first access point that complies with the multi-link communication defined in the IEEE 802.11 standard is displayed as the search result in such a manner as to be distinguishable by a user from other access points returned in the search.

Further features of the present disclosure will become apparent from the following description of exemplary embodiments with reference to the attached drawings.

### BRIEF DESCRIPTION OF THE DRAWINGS

FIG. 1 illustrates a configuration example of a network according to an exemplary embodiment of the present disclosure.

FIG. 2 is a sequence diagram illustrating processing for a start of multi-link communication.

FIG. 3 illustrates a format of a Reduced Neighbor Report (RNR) element.

FIG. 4 is a block diagram illustrating a hardware configuration example of an access point (AP) and a station (STA).

FIG. 5 is a block diagram illustrating a functional configuration example of the AP and the STA.

FIGS. 6A and 6B illustrate an example of a method of displaying a communication state that is displayed by a communication device.

FIGS. 7A and 7B illustrate an example of a method of displaying a communication state that is displayed by the communication device during AP search.

FIGS. 8A and 8B illustrate an example of a method of displaying a communication state that is displayed by the communication device.

FIGS. 9A to 9C illustrate operation modes for multi-link communication.

FIGS. 10A and 10B each illustrate an example of a method of displaying a communication state that is displayed by the communication device based on an operation mode.

FIGS. 11A to 11E each illustrate a method of displaying a communication state that is displayed by the communication device.

FIG. 12 is a flowchart illustrating processing that is performed in a case where the communication device displays a communication state.

FIG. 13 is a flowchart illustrating processing that is performed in a case where the communication device displays a communication state during AP search.

FIG. 14 is a flowchart illustrating processing that is performed in a case where the communication device displays a communication state based on an operation mode.

FIG. 15 is a flowchart illustrating processing that is performed in a case where the communication device displays a communication state based on an operation mode.

FIG. 16 illustrates an example of a report that is output by the communication device.

### DESCRIPTION OF THE EMBODIMENTS

Hereinafter, exemplary embodiments of the present disclosure will be described in detail with reference to the accompanying drawings. The configurations described in the following exemplary embodiments are merely examples, and the present disclosure is not limited to the illustrated configurations.

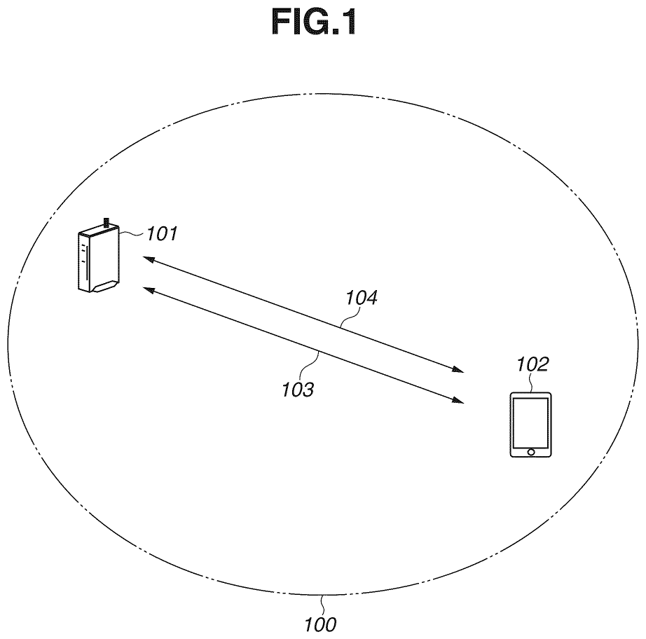

FIG. 1 illustrates a configuration example of a network including communication devices which are an access point (AP) and a station (STA) according to an exemplary embodiment of the present disclosure. FIG. 1 illustrates a configuration example of the network including one AP 101 and one STA 102. As illustrated in FIG. 1, the network formed by the AP 101 is represented by a circle 100. The STA 102 is configured to transmit and receive signals that are transmitted and received by the AP 101. The STA 102 may include not only a function as a station, but also as an access point, and may be configured to concurrently execute the function as the station and the function as the access point.

The STA 102 participates in the network formed by the AP 101. The AP 101 and the STA 102 are configured to execute wireless communication compliant with the Institute of Electrical and Electronics Engineers (IEEE) 802.11be Extremely (or Extreme) High Throughput (EHT) standard. The IEEE 802.11be standard is also referred to as Wi-Fi® 7. Each communication device is configured to perform communication in frequency bands of 2.4 GHz band, 5 GHz band, and 6 GHz band. The frequency bands used by each communication device are not limited to these frequency bands. Any other frequency bands, such as 60 GHz band, may also be used. The AP 101 and the STA 102 are configured to perform communication using bandwidths of 20 GHz, 40 MHz, 80 MHz, 160 MHz, and 320 MHz. The bandwidths used by each communication device are not limited to these bandwidths. Any other bandwidths, such as 240 MHz and 4 MHz, may also be used.

The AP 101 and the STA 102 that comply with the IEEE 802.11be standard may also comply with legacy standards that are standards prior to the IEEE 802.11be standard and may also comply with standards succeeding the IEEE 802.11be standard. Specifically, the AP 101 and the STA 102 may comply with at least one of the IEEE 802.11a/b/g/n/ac/ax standards. The AP 101 and the STA 102 may comply with not only the IEEE 802.11 series standards, but also other communication standards such as Bluetooth®, Near Field Communication (NFC), Ultra Wide Band (UWB), Zonal Intercommunication Global-standard (ZigBee), and Multi-Band Orthogonal Frequency-Division Multiple (OFDM) Alliance (MBOA). The UWB includes a wireless universal serial bus (USB), Wireless 1394, and WiMedia Network (WiNET). The AP 101 and the STA 102 may also comply with wired communication standards, such as a wired local area network (LAN). Specific examples of the AP 101 include a wireless LAN router, a personal computer (PC), a smartphone, and a tablet. However, the AP 101 is not limited to these examples. The AP 101 may also be an information processing device, such as a wireless chip, configured to execute wireless communication compliant with the IEEE 802.11be standard. While specific examples of the STA 102 include a camera, a tablet, a smartphone, a PC, a mobile phone, a video camera, a headset, a printing device, and a multi-function peripheral (MFP), the STA 102 is not limited to these examples.

The STA 102 may be an information processing device, such as a wireless chip, configured to execute wireless communication compliant with the IEEE 802.11be standard.

The AP 101 and the STA 102 establish links via a plurality of frequency channels and execute multi-link communication to establish communication. Multi-Link communication is defined in the IEEE 802.11 standard. An AP that executes multi-link communication is also referred to as an AP Multi-Link Device (MLD). In the IEEE 802.11 series standards, the bandwidth of each frequency channel is defined as 20 MHz. The term “frequency channel” as used herein refers to a frequency channel defined in the IEEE 802.11 series standards. In the IEEE 802.11 series standards, a plurality of frequency channels is defined for frequency bands of 2.4 GHz band, 5 GHz band, 6 GHz band, and 60 GHz band. A bandwidth of 40 MHz or higher may be used in one frequency channel by bonding the adjacent frequency channels. For example, the AP 101 establishes a link 103 with the STA 102 via a first frequency channel of 5 GHz band, to communicate with the STA 102. Concurrently, the STA 102 establishes a link 104 with the AP 101 via a second frequency channel of 6 GHz band, to communicate with the AP 101. In this case, the STA 102 executes multi-link communication to maintain the link 104 serving as the second link via the second frequency channel in parallel with the link 103 via the first frequency channel.

In the related art, an STA complying with the IEEE 802.11 standard connects to an access point and performs data communication with the access point via a single link. An improvement in throughput is achieved by connecting to an access point and performing data communication via two or more links at once by multi-link communication. In the IEEE 802.11be standard, supporting 6 GHz band has been studied to extend available frequency bands. The two or more links to be used may be selected from the same frequency band (any one of a sub-GHz band, 2.4 GHz band, 3.6 GHz band, 4.9 and 5 GHz bands, 60 GHz band, and 6 GHz band) or from different frequency bands. An AP complying with multi-link communication is referred to as an AP MLD, and an STA complying with multi-link communication is referred to as an STA MLD. APs that are associated with the AP MLD and operate using different channels are referred to as affiliated APs, and STAs that are associated with the STA MLD and operate using different channels are referred to as affiliated STAs. The affiliated APs are each denoted by adding a number to each AP, such as affiliated AP1, affiliated AP2, and ⋅ ⋅ ⋅ . The affiliated STAs are each denoted by adding a number to each STA, such as affiliated STA1, affiliated STA2, and ⋅ ⋅ ⋅ .

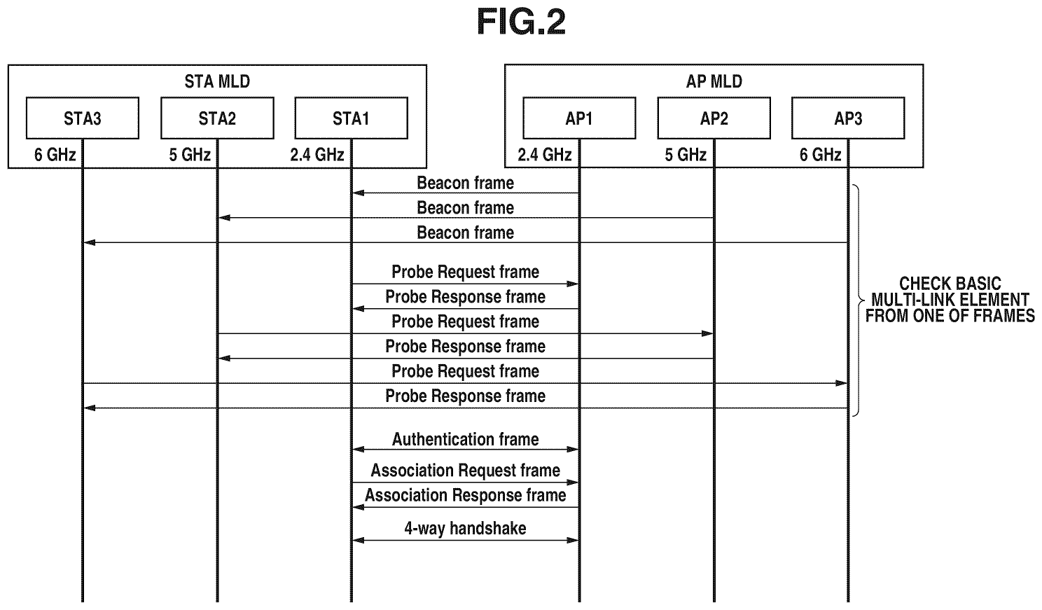

FIG. 2 is a sequence diagram illustrating an example of processing for multi-link communication. Multi-link communication setup processing is performed based on a Basic Multi-Link element, a Reduced Neighbor Report (RNR) element, or the like.

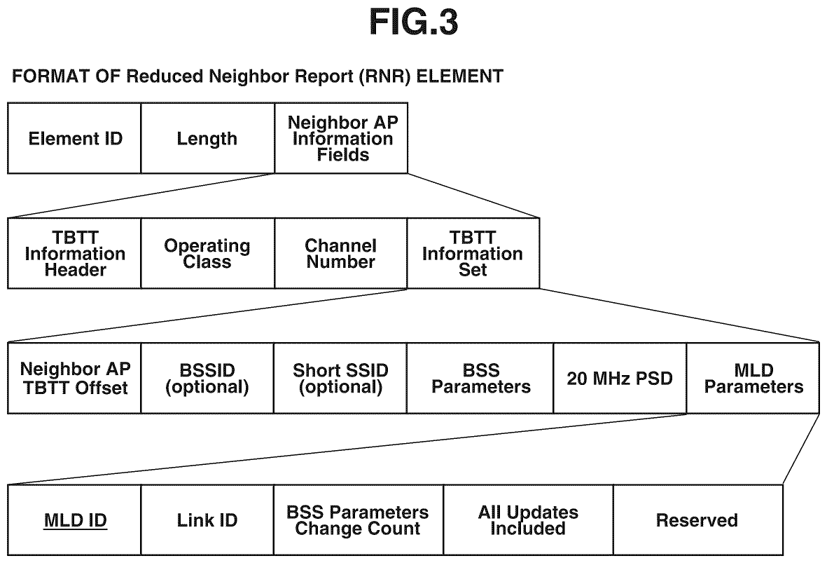

Each AP that is associated with each frequency band for data communication is referred to as an affiliated AP, and each STA that is associated with each frequency band for data communication is referred to as an affiliated STA. Determination of whether to establish a multi-link connection is performed based on a Basic Multi-Link element. The Basic Multi-Link element includes information such as an MLD identification (ID) and a link ID to be used for multi-link communication. The AP MLD includes the Basic Multi-Link element in a Beacon or Probe Response and transmits the Beacon or Probe Response. The STA MLD checks whether the Basic Multi-Link element is included in the Beacon or Probe Response transmitted from a certain affiliated AP, and determines whether the AP corresponds to the AP MLD. In a case where a partner AP corresponds to the AP MLD, frequency band information and channel information about other affiliated APs belonging to the same AP MLD are obtained from the RNR element included in the obtained Beacon or Probe Response. Determination of whether the affiliated APs belongs to the same AP is performed based on determination that the MLD ID included in the RNR element is “0”. FIG. 3 illustrates contents of the RNR element. The STA MLD switches a channel to an obtained channel, obtains detailed information about each affiliated AP, and establishes a multi-link connection with an affiliated AP to be connected based on the obtained information. Specifically, a Probe frame and an Authentication frame are exchanged for multi-link communication, and 4-Way Handshake (4WHS) processing is performed to establish a connection between the STA and the AP via a plurality of links, that is, a multi-link connection. In a case where the partner AP does not correspond to the AP MLD, the connection is established via a single frequency channel.

As described above, the AP 101 establishes links with the STA 102 via a plurality of frequency channels, whereby the throughput is improved in communication with the STA 102. A plurality of links in different frequency bands may be established between communication devices in multi-link communication. For example, the AP 101 and the STA 102 may establish a third link in 2.4 GHz band in addition to the link 103 in 5 GHz band and the link 104 in 6 GHz band. Alternatively, the AP 101 and the STA 102 may establish links via a plurality of different channels included in the same frequency band. For example, the AP 101 and the STA 102 may establish 15 ch in 6 GHz band as a first link and 207 ch in 6 GHz band as a second link. Links in the same frequency band and links in different frequency bands may coexist. For example, the AP 101 and the STA 102 may establish a link of 149 ch in 5 GHz band and a link of 15 ch in 6 GHz band, in addition to the link 103 of 36 ch in 5 GHz band. Since the AP 101 establishes a plurality of connections in different frequency bands with the STA 102, even in a case where communication in a certain bandwidth is congested, the AP 101 establishes communication in another bandwidth with the STA 102, which prevents deterioration of throughput in communication with the STA 102 and prevents a communication delay.

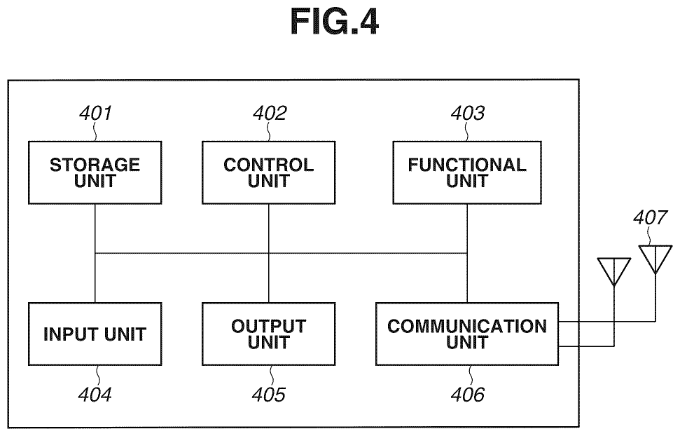

FIG. 4 is a block diagram illustrating a hardware configuration example of the AP 101 according to the present exemplary embodiment. The AP 101 includes a storage unit 401, a control unit 402, a functional unit 403, an input unit 404, an output unit 405, a communication unit 406, and an antenna 407. The AP 101 may include a plurality of antennas 407.

The storage unit 401 includes one or more memories, such as a read-only memory (ROM) and a random access memory (RAM), and stores computer programs for performing various operations to be described below and various information such as communication parameters for wireless communication. As the storage unit 401, not only memories such as a ROM and a RAM, but also storage media such as a flexible disk, a hard disk, an optical disk, a magneto-optical disk, a compact disc (CD)-ROM, a CD-Rewritable (R), a magnetic tape, a nonvolatile memory card, and a digital versatile disc (DVD) may be used. The storage unit 401 may include a plurality of memories and the like.

The control unit 402 includes, for example, one or more processors, such as a central processing unit (CPU) or a micro processing unit (MPU), and controls the overall operation of the AP 101 by executing computer programs stored in the storage unit 401. The control unit 402 may control the overall operation of the AP 101 by causing computer programs stored in the storage unit 401 and an operating system (OS) to cooperate with each other. The control unit 402 generates data and signals (wireless frames) to be transmitted in communication with another communication device. The control unit 402 includes a plurality of processors, such as a multi-core processor. The plurality of processors may control the overall operation of the AP 101.

The control unit 402 controls the functional unit 403 to execute wireless communication and predetermined processing such as image capturing, printing, or projection. The functional unit 403 is hardware to cause the AP 101 to execute the predetermined processing.

The input unit 404 receives various operations from a user. The output unit 405 performs various output operations for the user via a monitor screen or a speaker. In this case, the output operations by the output unit 405 may include display on a monitor screen, audio output from a speaker, and output of a vibration. The input unit 404 and the output unit 405 may be implemented as one module, like a touch panel. The input unit 404 and the output unit 405 may be integrated with the AP 101, or may be separate from the AP 101.

The communication unit 406 controls wireless communication compliant with the IEEE 802.11be standard. The communication unit 406 may control wireless communication compliant with not only the IEEE 802.11be standard, but also other IEEE 802.11 series standards, and may also control wired communication such as a wired LAN. The communication unit 406 controls the antenna 407 to transmit and receive signals for wireless communication generated by the control unit 402.

In a case where the AP 101 is compatible not only with the IEEE 802.11be standard, but also with the NFC standard, Bluetooth® standard, or the like, the AP 101 may control wireless communication compliant with such communication standards. In a case where the AP 101 is configured to execute wireless communication compliant with a plurality of communication standards, the AP 101 may include individual communication units and individual antennas compliant with the communication standards, respectively. The AP 101 communicates data, such as image data, text data, or video data, with a partner device via the communication unit 406. The antenna 407 may be separate from the communication unit 406, or the antenna 407 and the communication unit 406 may be integrated as one module.

The antenna 407 is an antenna capable of establishing communication in 2.4 GHz band, 5 GHz band, and 6 GHz band. In the present exemplary embodiment, the AP 101 includes two antennas 407, but instead may include three antennas. More alternatively, the AP 101 may include different antennas for each frequency band. In a case where the AP 101 includes a plurality of antennas 407, the AP 101 may include a plurality of communication units 406 each corresponding to a different one of the plurality of antennas. In the present exemplary embodiment, the STA 102 has a hardware configuration similar to that of the AP 101. However, the STA 102 may include at least one of a printing unit for printing image data on a print medium and a scanner unit for scanning a document. The STA 102 may include a camera unit for capturing images. Specifically, the STA 102 may be an image processing apparatus, such as a printer, a scanner, or an MFP, a mobile terminal, such as a smartphone or a tablet, a camera, or a PC.

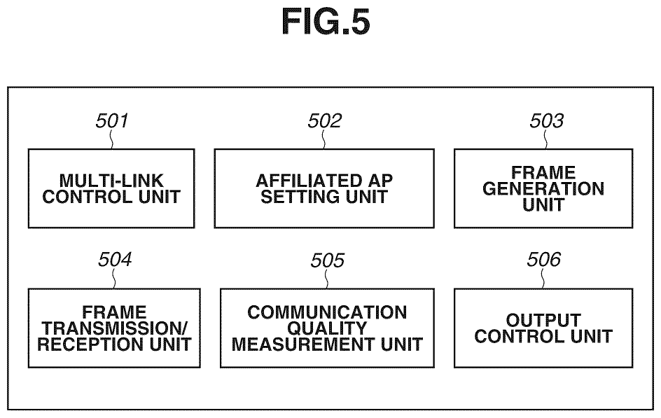

FIG. 5 is a block diagram illustrating a functional configuration example of the AP 101 according to the present exemplary embodiment. The STA 102 has a configuration similar to the configuration illustrated in FIG. 5, except that an affiliated AP setting unit 502 is replaced by an affiliated STA setting unit.

The AP 101 includes a multi-link control unit 501, the affiliated AP setting unit 502, a frame generation unit 503, a frame transmission/reception unit 504, a communication quality measurement unit 505, and an output control unit 506.

The multi-link control unit 501 is a block that controls communication start processing to cause the AP 101 to establish one or more links for wireless communication with the STA 102, link addition or deletion processing that is performed after start of communication, and communication termination processing to delete all links. Specific examples of connection processing include authentication processing, association processing, and 4WHS processing.

The affiliated AP setting unit 502 selects and determines affiliated APs in multi-link communication set by each user interface (UI) unit. The affiliated AP setting unit 502 also transmits a notification about affiliated APs to be used to the frame transmission/reception unit 504.

The frame generation unit 503 is a block that generates frames to be transmitted based on settings set by the affiliated AP setting unit 502.

The frame transmission/reception unit 504 transmits wireless frames, including Beacon/Probe Response frames and data frames generated by the frame generation unit 503 and receives wireless frames from the partner device, based on affiliated AP information received from the affiliated AP setting unit 502.

The communication quality measurement unit 505 measures and calculates the communication quality of Beacon/Probe Response frames received from the frame transmission/reception unit 504. While examples of communication quality information include Received Signal Strength Indicator (RSSI) and Signal-to-Noise Ratio (SNR), the communication quality information is not limited to these examples.

The output control unit 506 controls an output operation such as a screen output, an audio output, or a print output to provide information to the user. For example, a communication state of the STA 102 is displayed on a screen.

A first exemplary embodiment of the present disclosure will now be described. The present exemplary embodiment illustrates an example case in which information indicating multi-link communication is displayed using an icon or the like in a case where the communication device establishes multi-link communication.

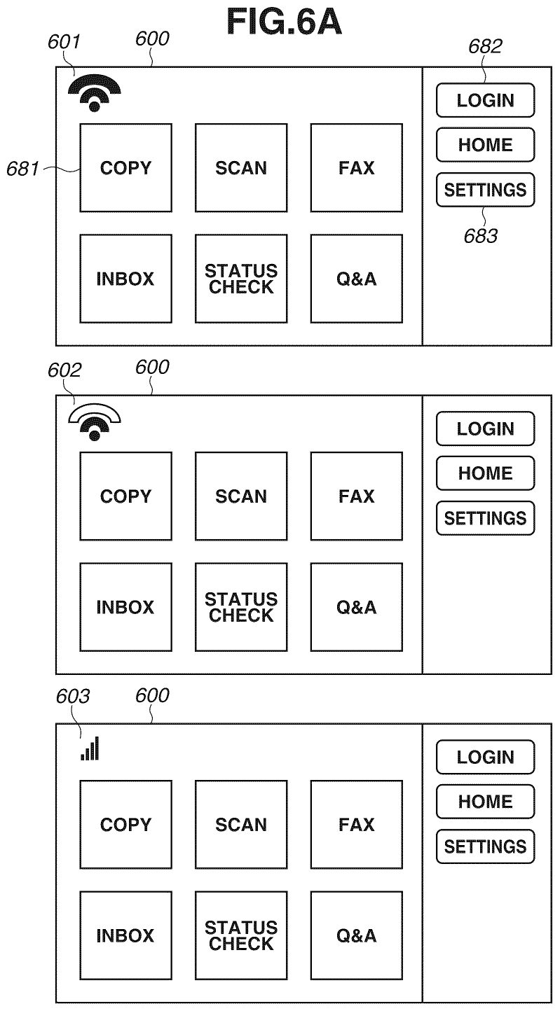

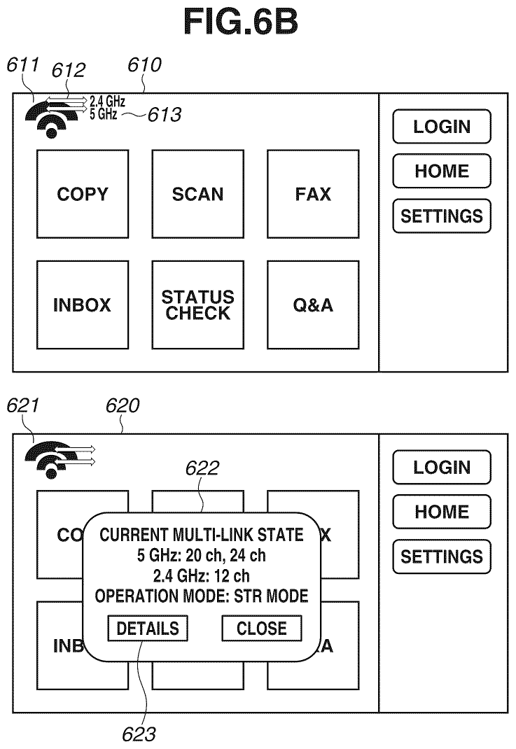

FIGS. 6A and 6B illustrate an example of a screen that is displayed on the output unit 405 by the STA 102 in a case where the STA 102 establishes a wireless LAN link with the AP 101. While, in the present exemplary embodiment, the STA 102 is an image processing apparatus including a printer and a scanner, the STA 102 is not limited to such an image processing apparatus.

A screen 600 is an example of a screen that is displayed on the output unit 405 in a case where the STA 102 establishes wireless LAN communication with the AP 101 via a single link. Specifically, the screen 600 is an example of a screen that is displayed by the STA 102 in a case where the STA 102 establishes wireless communication compliant with the IEEE 802.11 series standards with the AP 101 via a single link. The screen 600 is, for example, a home screen that is displayed immediately after the STA 102 is activated and is used by the user for selection of a function to be executed. For example, the user selects a copy icon 681 to cause the STA 102 to execute copy processing. The screen 600 further includes display items, such as a login button 682 that is used by the user to log into the STA 102, and a settings button 683 for various settings for the STA 102. An icon 601 is an example of a wireless LAN icon indicating that the STA 102 has established communication with the AP 101 via a single link. In the present exemplary embodiment, the icon 601 indicates a state where a single link is established, but instead a state where communication is performed using only one link may be indicated. Display and output examples in a case where multi-link communication is established will be described below. The present exemplary embodiment is also applicable in a configuration in which a state where “multi-link communication is established” is replaced by a state where “multi-link communication is being performed”. The state where “multi-link is established” indicates, for example, a state where the STA 102 and the AP 101 have performed multi-link setup processing, or a state where the STA 102 and the AP 101 have performed 4WHS processing after the multi-link setup processing. The state where “multi-link communication is being performed” indicates, for example, a state where a traffic identifier (TID) is allocated to each of a plurality of links, or a state where data is actually communicated via each link. The wireless LAN icon 601 includes a plurality of semi-circular arc-like objects. A radio field intensity in communication with the AP 101 may be displayed by changing the display of the objects. For example, the semi-circular arc-like object displayed on top of the screen, like an icon 602, may be displayed in white to indicate that the radio field intensity has decreased as compared with the radio field intensity indicated by the icon 601. As the radio field intensity decreases, the color of the displayed semi-circular arc-like objects is gradually changed to white in order from the top, which enables the user to visually recognize the radio field intensity. The icons 601 and 602 are examples of the wireless LAN icon. The shape of each icon is not limited to these examples. For example, like an icon 603, lines with different heights may be arranged and displayed. In this case, as the radio field intensity decreases, the color of the displayed lines is gradually changed to white in order from the rightmost line, which enables the user to visually recognize the radio field intensity. The display of the icon is not limited to this example, and the icon may have any shape as long as the icon indicates the communication state of the STA 102. For example, a character string may be used instead of the form of an icon.

A screen 610 is an example of a screen that is displayed on the output unit 405 by the STA 102 in a case where the STA 102 establishes links with the AP 101 via a plurality of frequency channels, that is, multi-link communication.

An icon 611 is an example of a multi-link icon indicating that the STA 102 has established links with the AP 101 via a plurality of frequency channels. In the present exemplary embodiment, the icon 611 indicates a state where a plurality of links is established, but instead a state where communication is being performed via a plurality of links as described above may be indicated. The icon 611 may include display objects, like the icon 601, and may indicate a radio field intensity by changing a display method. The shape of the icon 611 is not limited to this example. For example, the icon 611 may include linear objects, like the icon 603, instead of using semi-circular arc-like objects. In this case, the radio field intensity may indicate a radio field intensity of any one of the plurality of established links (e.g., a link with highest radio field intensity, or a link with lowest radio field intensity), or may indicate a calculated average value of radio field intensities of the plurality of established links. The icon 611 further includes display items 612 indicating that multi-link communication is established. In this case, two display items 612 are displayed to indicate that the STA 102 and the AP 101 have established two links. In a case where the STA 102 and the AP 101 have established three links, three display items 612 are displayed. While, in the present exemplary embodiment, double headed arrow shapes are displayed as the display items 612, the shape of the display items 612 is not limited to this example. Further, displaying of information indicating that multi-link communication is established is performable without providing any additional display item. Information indicating that multi-link communication is established may be displayed by changing the icon display method such that, for example, in a case where the communication device has established one link (single link), the icon 611 is turned on and the display of the icon 611 is changed to a blinking display in a case where the communication device has established multi-link communication. The icon 611 further includes a display item 613 indicating the frequency bandwidth of each of the established links. In this case, the display item 613 indicates that multi-link communication is established in two frequency bands of 2.4 GHz and 5 GHz. Not only the frequency band width of each of the established links, but also channel information and the like may be displayed.

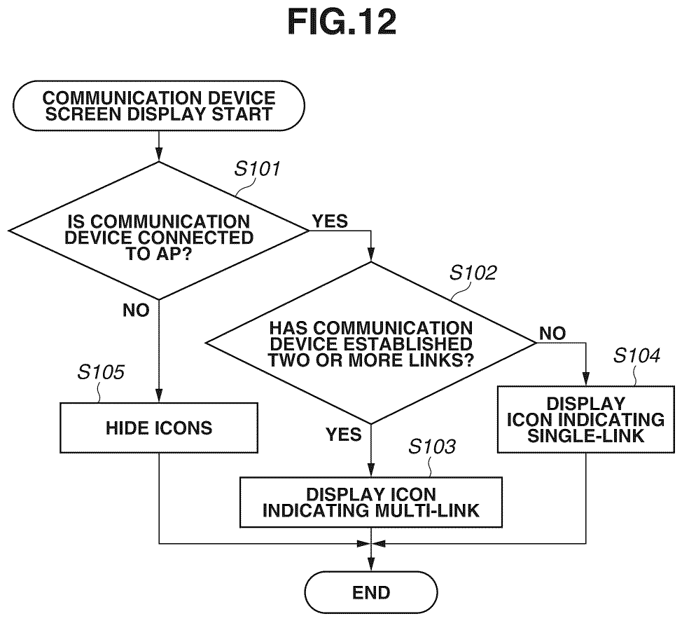

FIG. 12 is a flowchart illustrating processing for displaying screens illustrated in FIGS. 6A and 6B according to the present exemplary embodiment. The processing in this flowchart is started in response to the communication device (STA 102) receiving a screen display instruction from the user. Each process in the flowchart is implemented such that, for example, the control unit 402 loads programs stored in the storage unit 401 and executes the programs. The processing in this flowchart is repeatedly executed every predetermined period during a period in which the STA 102 displays the screen.

In step S101, the control unit 402 determines whether the STA 102 is connected to the AP 101. In a case where the control unit 402 determines that the STA 102 is not connected to the AP 101 (NO in step S101), the processing proceeds to step S105. In step S105, the control unit 402 hides icons (e.g., icons 601 and 611) indicating the communication state, and then the processing ends. In a case where the control unit 402 determines that the STA 102 is connected to the AP 101 (YES in step S101), the processing proceeds to step S102.

In step S102, the control unit 402 determines whether the STA 102 has established two or more links. In a case where the control unit 402 determines that the STA 102 has not established two or more links (NO in step S102), the processing proceeds to step S104. In step S104, the control unit 402 displays a wireless LAN icon (e.g., one of the icons 601, 602, and 603) indicating a single link, and then the processing ends. In a case where the control unit 402 determines that the STA 102 has established two or more links (YES in step S102), the processing proceeds to step S103. In step S103, the control unit 402 displays the icon 611 indicating multi-link, and then the processing ends.

In a case where the communication device has established multi-link communication, after the processing in the flowchart described above, the user can visually recognize that the communication device has established multi-link communication. While the present exemplary embodiment illustrates an example where the icon 611 or the like indicating the communication state is displayed on the home screen, the screen on which the communication state is displayed is not limited to the home screen. Also, in response to the screen transition to an application screen or the like, the communication state is displayed in the same manner. In other words, the icon 611 or the like indicating the communication state is displayed on a fixed area on the screen, which enables the user to constantly check the communication state.

The display indicating establishment of multi-link communication by the communication device is not limited to the display illustrated in FIGS. 6A and 6B.

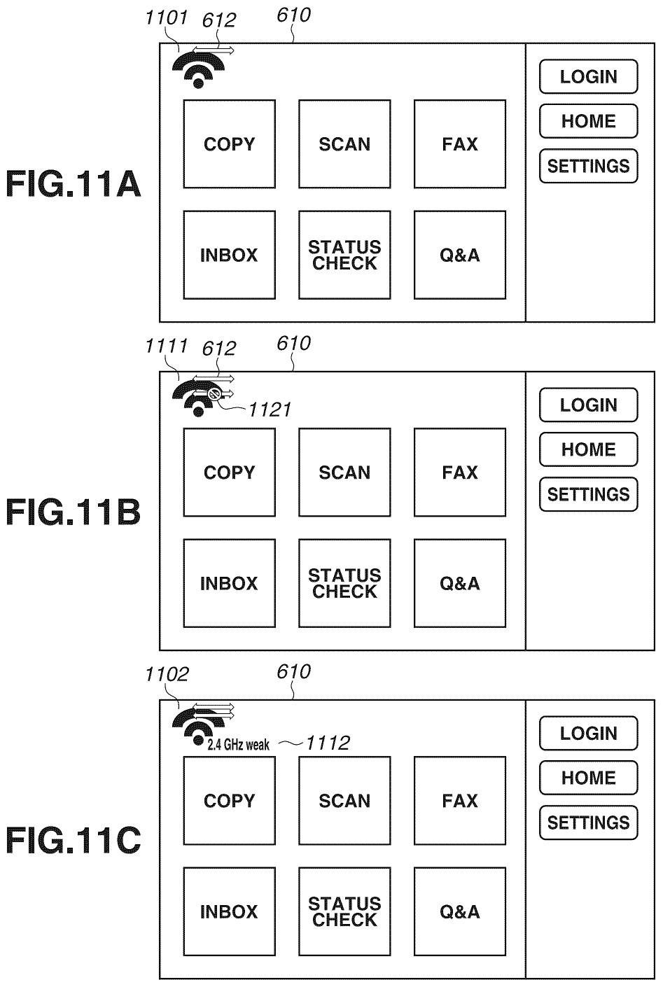

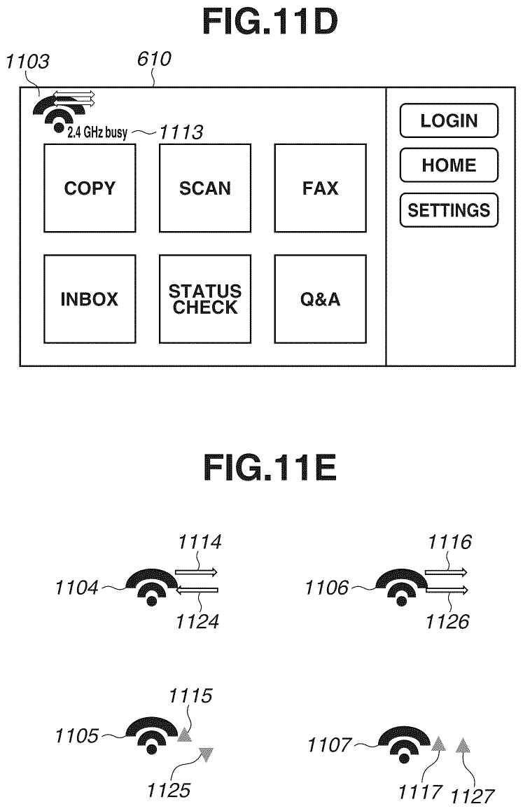

Other examples of the screen that is displayed on the output unit 405 by the STA 102 in a case where the STA 102 has established multi-link communication with the AP 101 will be described with reference to FIGS. 11A to 11E. In some cases, even in a case where the STA 102 has established multi-link communication with the AP 101, some of the established links are unusable due to radio wave interference or the like and the actual data communication may be performed using only available links. For example, in a case where the STA 102 has established a plurality of links with the AP 101 and is actually communicating with the AP 101 using one link, an icon 1101 illustrated in FIG. 11A may be displayed. The icon 1101 includes one display item 612. In other words, in a case where the communication device has established a plurality of links but performs data communication using only a predetermined link among the plurality of links, the icon 1101 is displayed. On the other hand, in a case where the communication device has established a plurality of links and performs data communication using the plurality of links, the icon 611 is displayed. This display operation enables the user to distinguish whether the communication device has established multi-link communication and whether the communication device performs data communication using a plurality of links. A state where the STA 102 has established a plurality of links with the AP 101 but actually performs communication using only one link may be displayed using an icon 1111 illustrated in FIG. 11B. The icon 1111 includes a display item 1121 indicating that data communication is not performed using predetermined established links. While, in the present exemplary embodiment, the display item 1121 is displayed on the display item 612 indicating links, the display of the display item 1121 is not limited to this example. The display item 1121 may be displayed over the entire icon 1111. The display item 1121 may be a display item such as “x” or “!”. The display of the display item 1121 enables the user to visually recognize that the STA 102 is not performing multi-link communication. The display item 1121 may be displayed in a case where the connected AP 101 has not established multi-link communication or is not performing multi-link communication although the AP 101 is compatible with multi-link communication. In this case, in a case where the connected AP 101 is not compatible with multi-link communication, the display item 1121 is not displayed even in a case where the connected AP 101 has not established multi-link communication or is not performing multi-link communication. In a case where the icon 1111 is selected by the user, the screen may transition to a screen for communication settings for the STA 102.

The icons 1101 and 1111 are examples of icons that are displayed in a case where the STA 102 has established a plurality of links and is actually performing communication using only one link. Alternatively, the icons 1101 and 1111 may be displayed in a case where the STA 102 has established one link. In this case, the display of the icons 1101 and 1111 is changed to the display of the icon 611 in a case where the STA 102 has established a plurality of links.

In a case where the STA 102 has established multi-link communication with the AP 101 using a plurality of bandwidths and the radio field intensity in a predetermined bandwidth is weak, information indicating that the radio field intensity has decreased may be displayed as an icon 1102 illustrated in FIG. 11C. The icon 1102 includes a display item 1112 indicating a bandwidth with a weak radio field intensity and information indicating that the radio field intensity is weak. In this case, the icon 1102 indicates that the radio field intensity in 2.4 GHz band is less than or equal to a predetermined threshold, for example, in a state where the STA 102 has established a link in 2.4 GHz band and a link in 5 GHz band. In a case where communication in a certain bandwidth among a plurality of links established by the STA 102 is in a congested state (busy state), an icon 1103 indicating a busy state as illustrated in FIG. 11D may be displayed. The icon 1103 includes a display icon 1113 indicating the busy bandwidth and information indicating that the communication is busy.

FIG. 11E illustrates variations of the multi-link icon. Icons 1104, 1105, 1106, and 1107 are icons each indicating that the STA 102 has established multi-link communication or performs multi-link communication. The icon 1104 includes a rightward arrow 1114 and a leftward arrow 1124. The rightward arrow 1114 may indicate data transmission to the AP 101 or uplink communication, and the leftward arrow 1124 may indicate data reception from the AP 101 or downlink communication. The icon 1105 includes an upward triangle 1115 and a downward triangle 1125. The upward triangle 1115 may indicate uplink communication, and the downward triangle 1125 may indicate downlink communication. In other words, in a case where the STA 102 performs uplink communication using one of the plurality of links and performs downlink communication using another link in the plurality of links, the icons 1104 and 1105 are displayed.

The icon 1106 includes a rightward arrow 1116 and a rightward arrow 1126. Each of the rightward arrow 1116 and the rightward arrow 1126 may indicate that uplink communication is performed. The icon 1107 includes an upward triangle 1117 and an upward triangle 1127. Each of the upward triangle 1117 and the upward triangle 1127 may indicate that uplink communication is performed. In other words, in a case where the STA 102 performs uplink communication via each of the plurality of links, the icons 1106 and 1107 are displayed. The display of each triangle may indicate a communication speed of each link and information indicating whether the communication speed increases. For example, the icon 1105 indicates that the STA 102 performs multi-link communication using two links, and the display of the upward triangle 1115 indicates that the communication speed of one of the two links is higher or increases. The display of the downward triangle 1125 indicates that the communication speed of the other of the two links is lower or decreases.

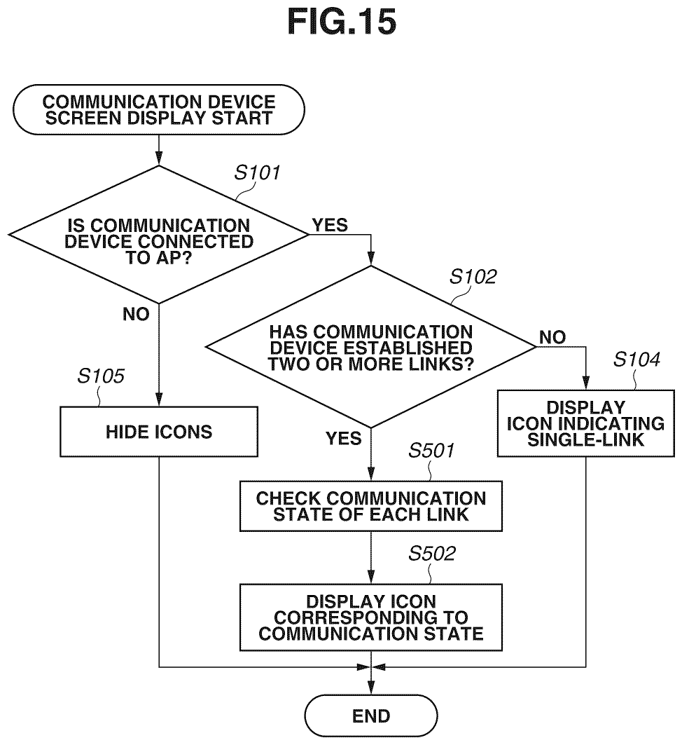

FIG. 15 is a flowchart illustrating processing for displaying screens illustrated in FIGS. 11A to 11E according to the present exemplary embodiment. The processing in this flowchart is started in response to the communication device receiving a screen display request. A basic configuration of this flowchart is similar to that illustrated in FIG. 12. The same processes are denoted by the same step numbers as those in FIG. 12, and the redundant descriptions are omitted. Only differences from the processing illustrated in FIG. 12 will be described. The processing in this flowchart is repeatedly executed every predetermined period during a period in which the STA 102 displays the screen.

In step S501, the control unit 402 checks the communication state of each of the plurality of established links.

In step S502, the control unit 402 displays an icon corresponding to the communication state checked in step S501, and then the processing ends. For example, in a case where the STA 102 has established communication with the AP 101 via two links and is performing data communication using only one link, the icon 1101 is displayed on the home screen.

As described above, according to the processing in the flowchart described above, the display of an icon enables the user to visually recognize the communication state in a case where the STA 102 and the AP 101 have established a plurality of links. This leads to an improvement in usability.

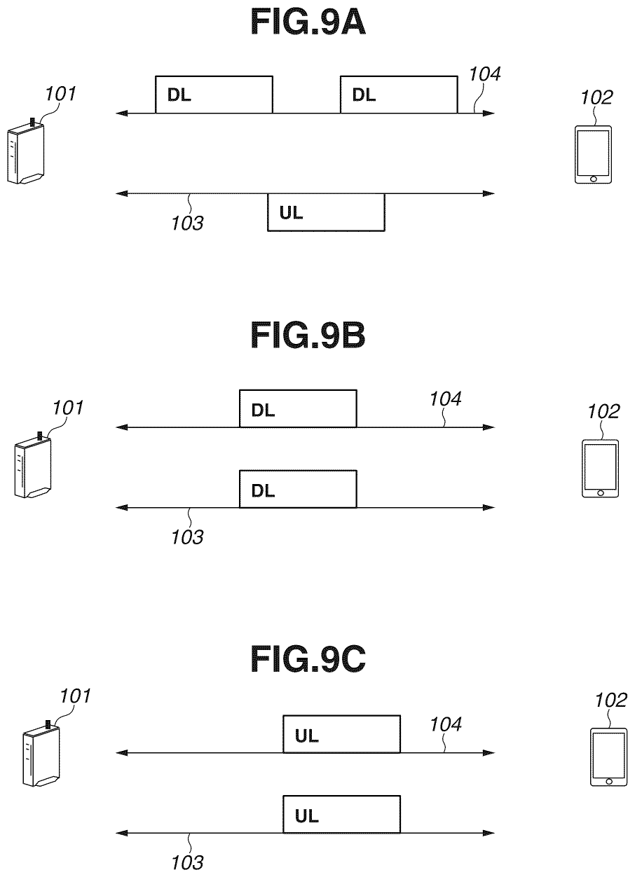

Yet another configuration example of indicating a multi-link communication state will be described. Multi-link communication includes two operation modes, i.e., a Simultaneous Transmit and Receive (STR) mode and a Nonsimultaneous Transmit and Receive (NSTR) mode. FIGS. 9A to 9C illustrate two operation modes, that is, the STR mode and the NSTR mode for multi-link communication. The STR mode is an operation mode in which two or more links function completely independently and do not interfere with each other. FIG. 9A illustrates a communication state of each link in the STR mode.

The AP 101 and the STA 102 have established two links 103 and 104. The link 103 performs uplink (UL) communication and the link 104 performs downlink (DL) communication. The operation mode in which one of the links performs reception processing and the other of the links performs transmission processing is referred to as the STR mode.

The NSTR mode is an operation mode in which two or more links do not concurrently perform reception and transmission operations and all the links perform one of data reception processing and data transmission processing at once. FIGS. 9B and 9C each illustrate a communication state of each link in the NSTR mode. FIG. 9B illustrates a state in which all links perform downlink communication processing, and FIG. 9C illustrates a state in which all links perform uplink communication processing. The operation mode in which all links perform one of data reception processing and data transmission processing at once is referred to as the NSTR mode.

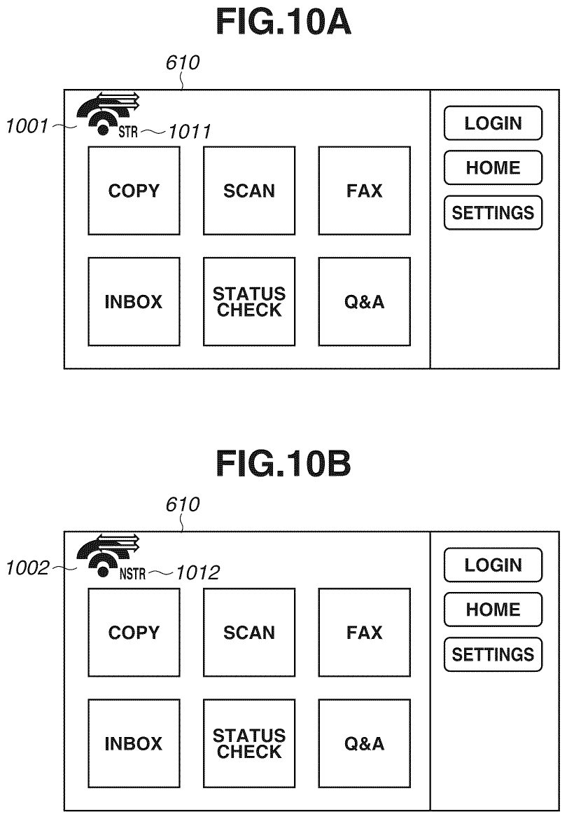

FIGS. 10A and 10B are examples of a screen that is displayed on the output unit 405 by the STA 102 in each operation mode for multi-link communication.

The screen 610 illustrated in FIG. 10A is a screen that is displayed in a case where the STA 102 operates in the STR mode. An icon 1001 is an icon that is displayed in a case where the STA 102 has established multi-link communication and operates in the STR mode. The icon 1001 includes an STR mode icon 1011 as a display item indicating that the STA 102 operates in the STR mode.

The screen 610 illustrated in FIG. 10B is a screen that is displayed in a case where the STA 102 operates in the NSTR mode. An icon 1002 is an icon that is displayed in a case where the STA 102 has established multi-link communication and operates in the NSTR mode. The icon 1002 includes an NSTR mode icon 1012 as a display item indicating that the STA 102 operates in the NSTR mode. In this case, character strings “STR” and “NSTR” are used to indicate the operation mode. Alternatively, an icon or the like may be used to indicate the operation mode.

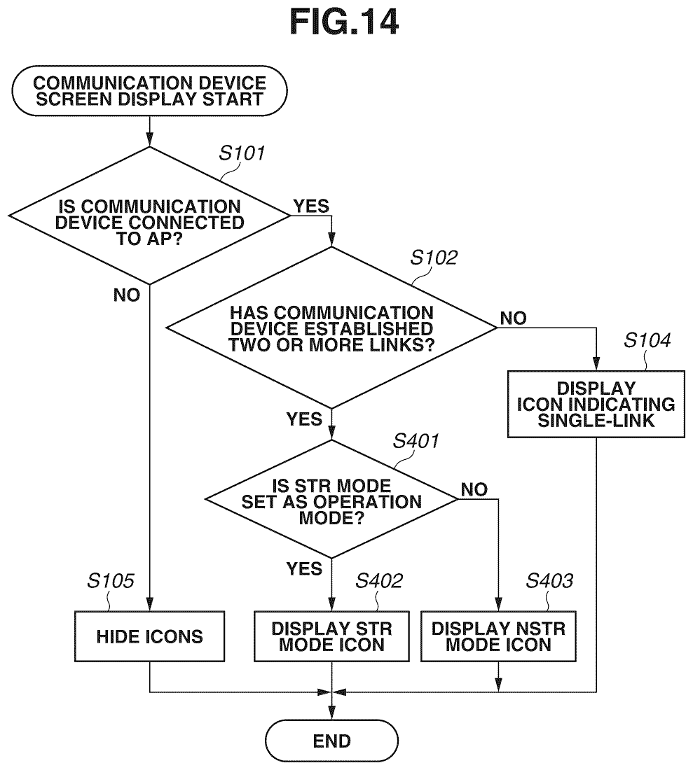

FIG. 14 is a flowchart illustrating processing for displaying screens illustrated in FIGS. 10A and 10B according to the present exemplary embodiment. The processing in this flowchart is started in response to the communication device receiving a screen display request. A basic configuration of this flowchart is similar to that illustrated in FIG. 12. The same processes are denoted by the same step numbers as those in FIG. 12, and the redundant descriptions are omitted. Only differences from the processing illustrated in FIG. 12 will be described. The processing in this flowchart is repeatedly executed every predetermined period during a period in which the STA 102 displays the screen.

In step S401, the control unit 402 determines whether the STR mode is set as the operation mode in multi-link communication with the AP 101. In a case where the control unit 402 determines that the STR mode is set (YES in step S401), the processing proceeds to step S402. In step S402, the control unit 402 displays the STR mode icon 1001, and then the processing ends. In a case where the control unit 402 determines that the STR mode is not set (NO in step S401), the processing proceeds to step S403. In step S403, the control unit 402 displays the NSTR mode icon 1002, and then the processing ends.

As described above, the processing in the flowchart described above enables the user to easily recognize the operation mode of the STA 102 in a case where the STA 102 executes multi-link communication. The present exemplary embodiment is characterized that the display is changed in accordance with the operation mode (STR mode, NSTR mode) during multi-link communication executed by the STA 102, and the shapes of icons are not limited to the above-described examples.

The first exemplary embodiment described above illustrates a configuration example in which the communication state in a case where the STA 102 has established a communication connection with the AP 101 is displayed. A second exemplary embodiment illustrates a configuration example in which, in a case where the STA 102 searches for APs with which the STA 102 is to establish a connection, information indicating whether each AP is compatible with multi-link communication is displayed in such a manner that the user can distinguish the compatibility. A basic configuration of the present exemplary embodiment is similar to that of the first exemplary embodiment. Only differences from the first exemplary embodiment will be described.

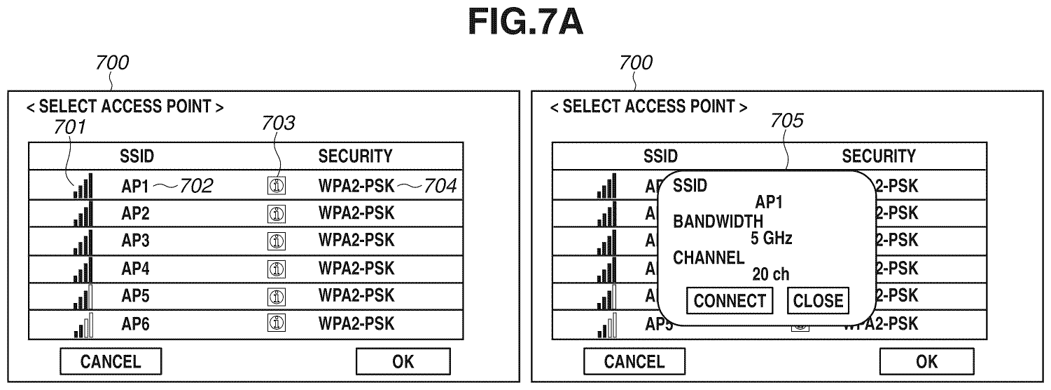

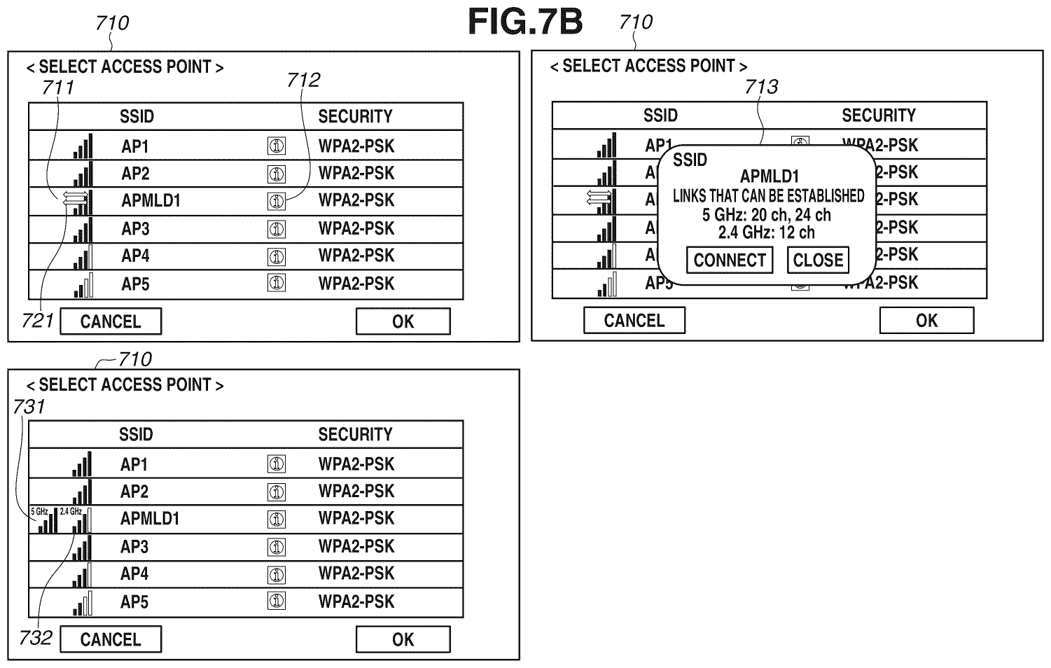

FIGS. 7A and 7B illustrate an example of an access point search result screen that is displayed, in a case where the STA 102 searches for the AP to be connected, on the output unit 405 to cause the user to select an AP to be connected. In response to a selection by the user being received on the screen, a connection to the selected AP is established via the control unit 402 or the functional unit 403. Then, the STA 102 performs printing of print data received via the selected AP, and transmits image data generated by image capturing or scanning to an external device via the selected AP.

A screen 700 is an example of the access point search result screen that is displayed on the output unit 405 by the STA 102. Information about a plurality of APs searched by the STA 102 is displayed in each row. An icon 701 indicates a radio field intensity of a signal transmitted from each AP. The icon 701 is merely an example, and the shape of the icon to be displayed is not limited to this example. An item 702 indicates a service set identifier (SSID) of the corresponding AP. When the user presses a details button 703, a pop-out window 705 is displayed, so that detailed information about each AP is displayed. The pop-out window 705 displays frequency bandwidth information, channel information, and the like about the corresponding AP. Security information 704 indicates information about the security of the corresponding AP. The screen 700 is merely an example, and the contents to be displayed are not limited to this example. For example, frequency bandwidth information and channel information to be used by the corresponding AP may be displayed.

A screen 710 is an example of the access point search result screen that is displayed in a case where the STA 102 searches for APs and the AP that is compatible with multi-link communication, or the AP MLD has been detected. An item “APMLD1” in the column of SSID indicates the SSID of the AP MLD. An icon 711 is a multi-link icon indicating the radio field intensity of the corresponding AP, and also indicating the AP MLD configured to execute multi-link communication. In addition to the icon indicating the radio field intensity, a display item 721 indicating that the AP is compatible with multi-link communication is added to the icon 711. The display items 721 added to the icon 711 may be the same in number as links that is capable of being established by the corresponding AP. On the other hand, the display item 721 is not added to an AP that is not compatible with multi-link communication. The icon 711 is merely an example, and the shape of the icon to be displayed is not limited to this example. An AP MLD details screen 713 is a screen that is displayed in response to an AP MLD details button 712 being pressed, and indicates information about links that is capable of being established. In this case, frequency bandwidth information and channel information about links that is capable of being established by the AP MLD are displayed.

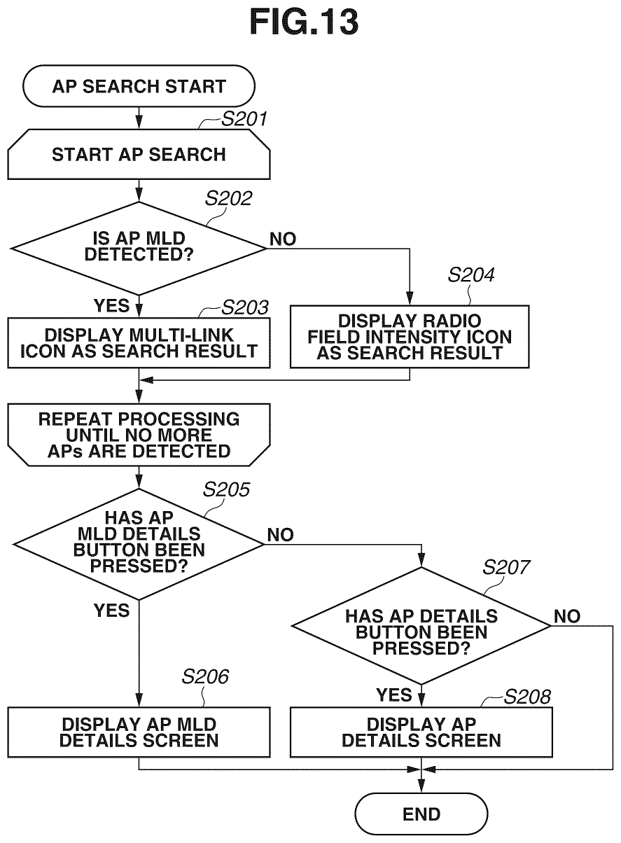

FIG. 13 is a flowchart illustrating processing for displaying screens illustrated in FIGS. 7A and 7B according to the present exemplary embodiment. The processing in this flowchart is started in response to a request from the user and AP search processing being started in the STA 102. The processing in this flowchart is repeatedly executed every predetermined period during a period in which the STA 102 displays the screen.

In step S201, the control unit 402 starts AP search processing.

In step S202, the control unit 402 determines whether each detected AP is compatible with multi-link communication. In a case where the detected AP is compatible with multi-link communication (YES in step S202), the processing proceeds to step S203. In a case where the detected AP is not compatible with multi-link communication (NO in step S202), the processing proceeds to step S204. The determination as to whether each detected AP is compatible with multi-link communication is performed based on a Basic Multi-Link element, a Reduced Neighbor Report element, or the like included in a Beacon or Probe transmitted from the AP. While, in the present exemplary embodiment, the determination of whether each detected AP is compatible with multi-link communication is performed, the determination is not limited to this example. For example, determination of whether each detected AP complies with standards succeeding the IEEE 802.11be standard may be performed.

In step S203, the control unit 402 displays the multi-link icon 711 indicating that the AP is compatible with multi-link communication as an access point search result.

In step S204, the control unit 402 displays the icon 701 indicating the radio field intensity as the access point search result. The above-described processing is repeatedly performed by the number of times corresponding to the number of APs detected by the STA 102. After all the APs detected by the STA 102 are displayed, the processing proceeds to step S205.

In step S205, the control unit 402 determines whether the AP MLD details button 712 has been pressed. In a case where the control unit 402 determines that the AP MLD details button 712 has been pressed (YES in step S205), the processing proceeds to step S206. In step S206, the control unit 402 displays the AP MLD details screen 713, and then the processing ends. In a case where the control unit 402 determines that the AP MLD details button 712 has not been pressed (NO in step S205), the processing proceeds to step S207.

In step S207, the control unit 402 determines whether the details button 703 has been pressed.

In a case where the control unit 402 determines that the details button 703 has been pressed (YES in step S207), the processing proceeds to step S208. In step S208, the control unit 402 displays the pop-out window 705, and then the processing ends. In step S207, in a case where the control unit 402 determines that the details button 703 has not been pressed (NO in step S207), the processing ends.

The processing in the flowchart described above enables the user to easily distinguish whether the AP is compatible with multi-link communication or is not compatible with multi-link communication, during the AP search. This leads to an improvement in usability. For example, the user who prioritizes a communication speed selects an AP that is compatible with multi-link communication, which achieves high-speed communication. According to the present exemplary embodiment, a multi-link icon that is different from an icon for an AP that does not correspond to the AP MLD is displayed on the AP search screen in a case where the STA 102 detects the AP MLD during the AP search, and the shape of the icon is not particularly limited.

The method of displaying an AP compatible with multi-link communication is not limited to the above-described method. For example, information indicating that the AP is compatible with multi-link communication may be displayed using icons such as icons 731 and 732. For example, in a case where the AP MLD1 is capable of establishing multi-link communication in 2.4 GHz band and 5 GHz band, the icon 731 including a display item indicating 5 GHz and a radio field intensity in 5 GHz, and the icon 732 including a display item indicating 2.4 GHz and a radio field intensity in 2.4 GHz are displayed. In this case, “APMLD1” is an example of the AP MLD compatible with 5 GHz and 2.4 GHz. In a case where the AP MLD is also compatible with 6 GHz, the radio field intensity in 6 GHz may also be displayed. In other words, icons displayed to indicate radio field intensities may be the same in number as bandwidths supported by the AP may be displayed.

The first and second exemplary embodiments described above illustrate an example where the communication state of the communication device is displayed on the home screen or the like. The method of outputting the communication state of the communication device so that the user can recognize the communication state is not limited to the above-described method. For example, the user may check the communication state on a communication setting screen of the communication device. Further, in a case where the communication device is an image processing apparatus, such as a printer, the communication device may also include a function for printing a report indicating a communication state or the like. A third exemplary embodiment illustrates an example case in which the communication state is output in such a manner. A basic configuration of the present exemplary embodiment is similar to that of the first exemplary embodiment, and thus only differences from the first exemplary embodiment will be described.

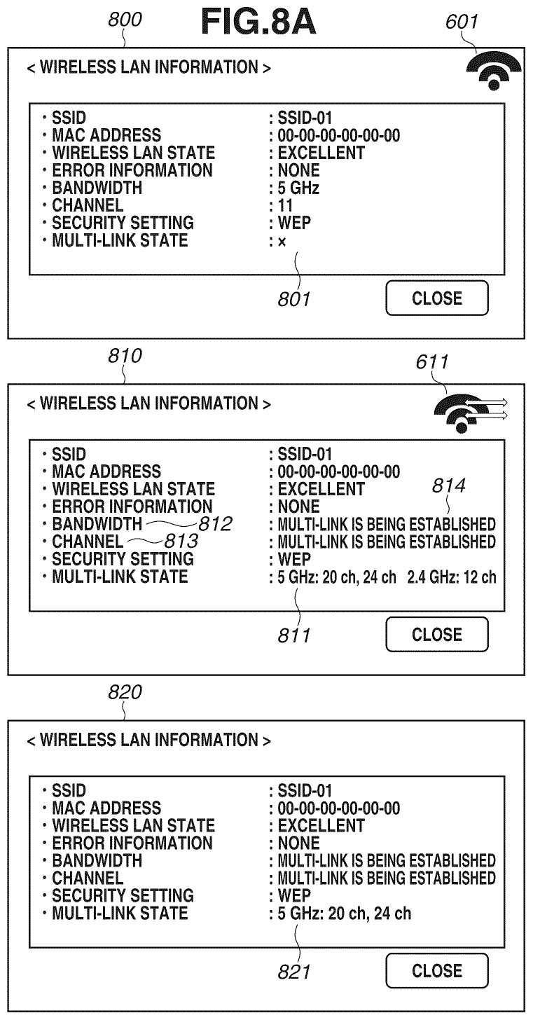

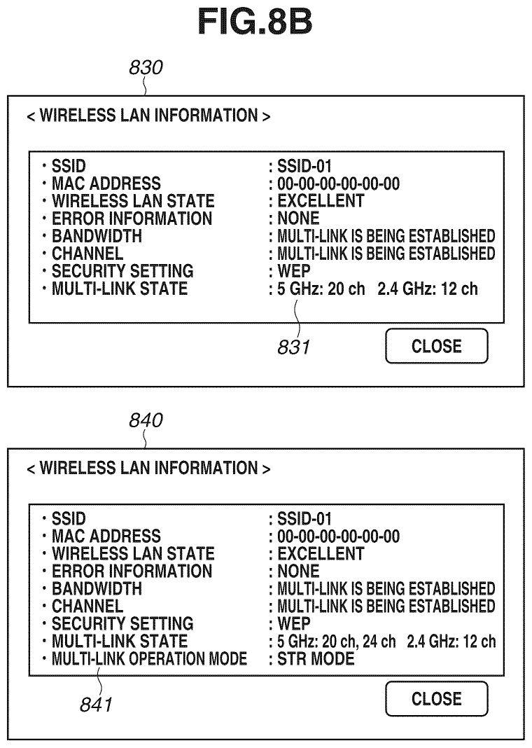

FIGS. 8A and 8B illustrate an example of wireless LAN information that is displayed on the output unit 405 by the STA 102 in a case where the STA 102 has established a communication link with the AP 101. FIGS. 8A and 8B illustrate an example of screens that are displayed in response to, for example, the user selecting the settings button 683 and also selecting a button to check the communication state on the communication setting screen.

A screen 800 is an example of wireless LAN information that is displayed on the output unit 405 in a case where the STA 102 has established one link with the AP 101. In response to the STA 102 receiving a display request from the user, or in response to establishment of a link with the AP 101 by the STA 102, the STA 102 displays the screen 800 on the output unit 405. For example, a multi-link state 801 indicates a multi-link communication state of the connected STA 102. In this case, “x” is displayed as the multi-link state 801 to indicate that the STA 102 and the AP 101 have not established multi-link communication. In addition, the screen 800 also includes information about the SSID or media access control (MAC) address of the AP, wireless LAN state information indicating a radio field intensity or a degree of congestion, error information indicating whether a communication error has occurred, and information about a frequency band, a channel, and a security setting to be used for communication. Like the screen 600, the screen 800 further includes the icon 601 indicating that communication is established using one link.

The wireless LAN information included in the screen 800 is merely an example, and is not limited to this example.

A screen 810 is an example of wireless LAN information that is displayed on the output unit 405 by the STA 102 in a case where the STA 102 has established links with the AP 101 via a plurality of frequency channels.

A multi-link state 811 indicates information about a frequency band and a channel of each of the plurality of links established by the STA 102. For example, in a case where the STA 102 has established a link of 20 ch in 5 GHz band, a link of 24 ch in 5 GHz band, and a link of 12 ch in 2.4 GHz band with the AP 101, information such as the multi-link state 811 is displayed. In other words, pieces of link information which are the same in number as links established by the STA 102 with the AP 101 are displayed as the multi-link state 811. For example, in a case where links of two or more channels are established for one frequency bandwidth, more specifically, in a case of establishing two links of 20 ch and 24 ch in 5 GHz band, information such as a multi-link state 821 may be displayed. For example, in a case where a link of one channel is established for each of two or more bandwidths, more specifically, in a case of establishing a link of 24 ch in 5 GHz band and a link of 12 ch in 2.4 GHz band, information such as a multi-link state 831 may be displayed. The method of indicating the multi-link state is not limited to this example. For example, frequency band information and channel information about each link may be displayed on display areas corresponding to bandwidth information 812 and channel information 813, respectively, on the screen 810. In the present exemplary embodiment, information 814 indicating that links are established via a plurality of frequency channels is displayed on display areas corresponding to the bandwidth information 812 and the channel information 813. The screen 810 further includes the icon 611 indicating multi-link communication in a fixed area at an end of the screen. In a case where the STA 102 has established multi-link communication and operates in the STR mode, information indicating the STR mode, such as a multi-link operation mode 841, is displayed on a screen 840. Multi-link state screens 810, 820, 830 and 840 illustrated in FIGS. 8A and 8B are merely examples of the method of displaying frequency channel information about a plurality of links, and the multi-link state screens to be used are not limited to these examples. For example, the bandwidth information 812 may be divided into “bandwidth 1” and “bandwidth 2”, and “bandwidth 1: 5 GHz” and “bandwidth 2: 2.4 GHz” may be displayed for the respective bandwidths. Also, the channel information 813 may be displayed in a divided manner, for example, “channel 1: 20 ch, 24 ch” and “channel 2: 12 ch”, in association with bandwidth information.

For example, information indicating whether an error has occurred may be displayed for each of the established links as error information on the screen 810. Channel information about a link in which an error has occurred may be displayed in a distinguishable manner from channel information about a link in which no error has occurred. Further, the radio field intensity of each of the established link may be displayed in a display field corresponding to the wireless LAN state. In this case, the multi-link state is displayed by obtaining the information and state of each link established by the STA 102 and the AP 101, for example, as in the first exemplary embodiment. The method for the STA 102 to obtain the communication state and display the obtained communication state is similar to that in the first and second exemplary embodiments, and thus the redundant descriptions are omitted.

A screen 620 illustrated in FIG. 6B is an example of a screen that is displayed on the output unit 405 by the STA 102 in a case where the STA 102 has established multi-link communication with the AP 101. The screen 620 includes an icon 621 indicating that multi-link communication is established. For example, in response to the user selecting the icon 621 by a touch operation or the like, a pop-out window 622 is displayed. The pop-out window 622 includes information indicating the current communication status of the STA 102. In the present exemplary embodiment, the information indicates the multi-link state. While, in the present exemplary embodiment, information indicating a frequency band and a channel and information indicating the operation mode, such as the STR mode or the NSTR mode, are used as the information indicating the multi-link state, the information indicating the multi-link state is not limited to these examples.

In response to the user selecting a details button 623 in the pop-out window 622, the screen 810 is displayed.

A configuration in which the communication state is output as a report in a case where the STA 102 is an image processing apparatus, such as a printer, will be described. The STA 102 stores the report in the storage unit 401. The report includes information, such as operation history information and setting information, about the STA 102. The operation history information refers to history information indicating print processing, wireless communication, and the like executed by the control unit 402 and the functional unit 403, for example, in a case where the STA 102 is an image processing apparatus. The setting information refers to information about various settings set for operation of the STA 102. The report includes information about, for example, the remaining amount of toner, the number of print pages, an address filter, Security Architecture for Internet Protocol (IPSec), a security setting status, and a communication state. A function of the STA 102 that outputs the report via the functional unit 403 or the output unit 405 is referred to as a report output function. The STA 102 may print the report via the functional unit 403, may display the report on a monitor screen via the output unit 405, or may transmit the report to an external device, such as a PC, by communication via the functional unit 403 and may display the report. The report output method is not limited to these examples. An example where the communication state is printed out as the report will be described below. However, the report may be output by any other method.

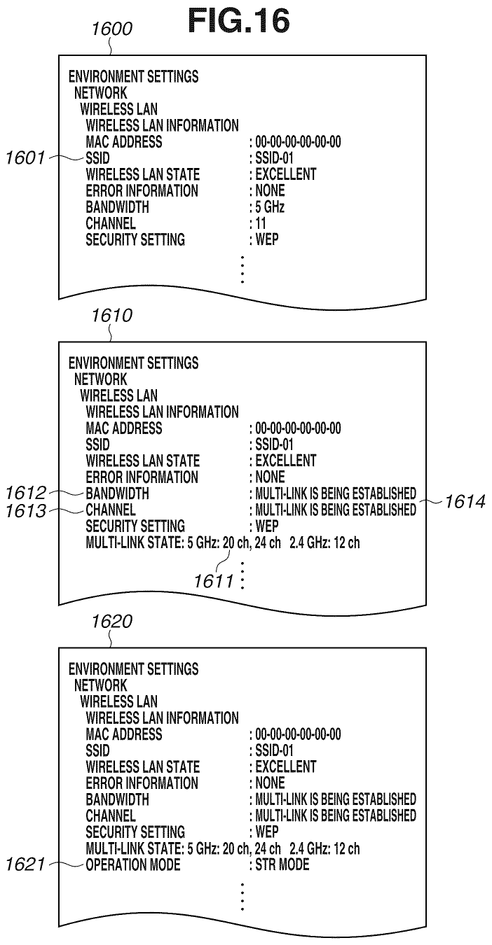

FIG. 16 illustrates an example of the report. A report 1600 is an example of a report output sheet printed by the STA 102 via the functional unit 403 in a case where the STA 102 has established one link with the AP 101. The report 1600 is a report indicating wireless LAN setting information about the STA 102, and indicates a communication state or information about the AP 101 connected to the STA 102. For example, information 1601 indicates the SSID of the connected AP 101. As the report 1600 indicating wireless LAN setting information, information about the bandwidth and the channel of the connected AP 101, or wireless LAN radio wave information may also be displayed. The report 1600 indicating wireless LAN setting information is merely an example, and the report is not limited to this example.

A report 1610 is an example of a report output sheet printed by the STA 102 via the functional unit 403 in a case where the STA 102 has established links with the AP 101 via a plurality of frequency channels and executes multi-link communication. Information 1611 indicates information about the frequency band and the channel of each of the plurality of links established by the STA 102. For example, in a case where the STA 102 has established a link of 20 ch in 5 GHz band, a link of 24 ch in 5 GHz band, and a link of 12 ch in 2.4 GHz band with the AP 101, the information 1611 about the multi-link state is output. In the present exemplary embodiment, multi-link states which are the same in number as the links established by the STA 102 with the AP 101 are output in a manner illustrated as the multi-link states 821 and 831. The method of indicating the multi-link state is not limited to this example. For example, frequency band information and channel information about each link may be output on display areas corresponding to bandwidth information 1612 and channel information 1613, respectively, on the report 1610. In this case, for example, information 1614 indicating that links are established via a plurality of frequency channels is output on display areas corresponding to the bandwidth information 1612 and the channel information 1613. In a case where the STA 102 has established multi-link communication and operates in the STR mode, information indicating the STR mode, such as a multi-link operation mode 1621 in a report 1620, may be output. The reports 1610 and 1620 are merely examples of the method for outputting frequency channel information about a plurality of links, and the information output method is not limited to these examples. For example, the bandwidth information 1612 may be divided into “bandwidth 1” and “bandwidth 2”, and “bandwidth 1: 5 GHz” and “bandwidth 2: 2.4 GHz” may be output. Also, the channel information 1613 may be divided into “channel 1: 20 ch, 24 ch” and “channel 2: 12 ch” and output in association with bandwidth information. Further, for example, information indicating whether an error has occurred may be displayed for each of the established links as error information on the report 1610. Channel information about a link in which an error has occurred may be displayed in a distinguishable manner from channel information about a link in which no error has occurred. In the present exemplary embodiment, the multi-link state is output by obtaining the information and state of each of links established by the STA 102 and the AP 101, for example, as in the first exemplary embodiment. In response to receipt of a report print instruction from the user, the STA 102 prints out the report.

The configuration described above enables the user to recognize that the STA 102 has established multi-link communication and information about each of a plurality of links. This leads to an improvement in usability.

### Other Exemplary Embodiments

The above-described first to third exemplary embodiments may be combined as appropriate. While the above-described exemplary embodiments illustrate an example where information indicating multi-link communication in the STA 102 connected to the AP 101 is displayed or output, information indicating multi-link communication in the AP 101 may be display or output. Further, the AP 101 may be a device including a function as an STA and a function as an AP. The configuration for displaying or outputting information indicating multi-link communication according to the present disclosure is also applicable to a device that directly performs wireless communication without involving an external AP. While the above-described exemplary embodiments illustrate a configuration example where information indicating multi-link communication is displayed or output, the configuration is not limited to this example. Information indicating whether an AP complies with the IEEE 802.11be standard (or succeeding standards) may be displayed or output. In this case, the information is output using, for example, a character string “be”.

A recording medium in which program codes of software for realizing the above-described functions are recorded may be supplied to a system or an apparatus, and a computer (CPU or MPU) of the system or the apparatus may read and execute the program codes stored in the recording medium. In this case, the program code itself read from the storage medium realizes the functions of the above-described exemplary embodiments, and the storage medium storing the program code constitutes the above-described apparatus.

As the storage medium for supplying the program code, for example, a flexible disk, a hard disk, an optical disk, a magneto-optical disk, a CD-ROM, a CD-R, a magnetic tape, a nonvolatile memory card, a ROM, a DVD, or the like can be used.

The functions described above may be implemented not only by executing the program code read by the computer but also by causing an operating system (OS) running on the computer to perform part or all of actual processing on the basis of an instruction of the program code.

Furthermore, the program code read out from the storage medium is written in a memory disposed in a function expansion board inserted into the computer or a function expansion unit connected to the computer.

A CPU disposed in the function expansion board or the function expansion unit may perform a part or all of the actual processing based on the instructions of the program code to realize the above-described functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-202363, filed Nov. 30, 2023, which is hereby incorporated by reference herein in its entirety.

What is claimed is:

1. A communication device that executes communication compliant with Institute of Electrical and Electronics Engineers (IEEE) 802.11 standard, the communication device comprising:
at least one memory storing instructions; and
at least one processor in communication with the at least one memory and, upon executing the stored instructions, the at least one processor is configured to operate as:
a search unit configured to search for an access point; and
a display control unit configured to cause display, on a display device, search results representing one or more access points returned from the search,
wherein a first access point that complies with the multi-link communication defined in the IEEE 802.11 standard is displayed as the search result in such a manner as to be distinguishable by a user from other access points returned in the search.

2. The communication device according to claim 1, wherein execution of the stored instructions further configures the display control unit to
display a second access point that does not comply with the multi-link communication defined in the IEEE 802.11 standard as the search result in such a manner as to be distinguishable from the first access point.

3. The communication device according to claim 1, wherein execution of the stored instructions further configures the display control unit to
display the first access point as the search result by adding a first display item indicating compliance with the multi-link communication.

4. The communication device according to claim 3, wherein the first display item includes a second display item indicating a radio field intensity of a signal transmitted from the access point.

5. The communication device according to claim 3, wherein the first display item includes a second display item indicating a radio field intensity of a signal for each link transmitted from the access point.

6. The communication device according to claim 3, wherein the first display item includes a third display item, the number of which is same as the number of links via which multi-link communication is to be established by the access point.

7. The communication device according to claim 1, further comprising a printing unit configured to receive print data via the first access point returned by the search unit and print the print data.

8. The communication device according to claim 1, wherein execution of the stored instructions further configures the display control unit to further display frequency band information and channel information about each link via which multi-link communication is to be established by the first access point.

9. The communication device according to claim 1, execution of the stored instructions further configures the at least one processor to operate as a determination unit configured to determine whether the access point returned in the search by the search unit is compatible with multi-link communication.

10. The communication device according to claim 9, wherein execution of the stored instructions further configures the determination unit to determine whether an access point returned in the search is compatible with multi-link communication, based on one of a Basic Multi-Link element and a Reduced Neighbor Report element in a Beacon or Probe transmitted from the access point.

11. The communication device according to claim 1, wherein the communication device operates as either a station or an access point.

12. A method for a communication device capable of executing communication compliant with Institute of Electrical and Electronics Engineers (IEEE) 802.11 standard, the method comprising:
searching for an access point; and
causing display, on a display device, search results representing one or more access points returned from the search,
wherein a first access point that complies with the multi-link communication defined in the IEEE 802.11 standard is displayed as the search result in such a manner as to be distinguishable by a user from other access points returned in the search.

13. A non-transitory computer-readable storage medium that stores one or more programs including instructions, which when executed by one or more processors of a communication device capable of executing communication compliant with Institute of Electrical and Electronics Engineers (IEEE) 802.11 standard, to perform a control method, the control method comprising:
searching for an access point; and
causing display, on a display device, search results representing one or more access points returned from the search,
wherein a first access point that complies with the multi-link communication defined in the IEEE 802.11 standard is displayed as the search result in such a manner as to be distinguishable by a user from other access points returned in the search.
